(19) United States
(12) Patent Application Publication
(10) Pub. No.: US 2015/0175225 A1
(43) Pub. Date: Jun. 25, 2015

(54) CRAWLER-TYPE BAR FOR A PISTE VEHICLE AS WELL AS A CRAWLER CHAIN WITH CRAWLER-TYPE BARS

(71) Applicant: Hans Hall GmbH, Weingarten (DE)

(72) Inventor: Hans HALL, Weingarten (DE)

(21) Appl. No.: 14/559,016

(22) Filed: Dec. 3, 2014

(30) Foreign Application Priority Data
Dec. 20, 2013 (DE) 20 2013 011 423.1

(51) Int. Cl. B62D 55/28

(52) U.S. Cl. CPC B62D 55/286

(57) ABSTRACT

A crawler-type bar for a piste vehicle consisting of an elongated bar basic body and an edge which is realized over at least one third of the length of the basic body. According to the present invention, the edge has several edge portions which, when viewed transversely with respect to the direction of the bar, extend at a spacing and at least in part not overlapping with another bar portion.

This application claims the benefit under 35 USC §119(a)-(d) of German Utility Model Application No. 20 2013 011 423.1 filed Dec. 20, 2013, the entirety of which is incorporated herein by reference.

### FIELD OF THE INVENTION

The invention relates to a crawler-type bar for a piste vehicle as well as a crawler chain with crawler-type bars.

### BACKGROUND OF THE INVENTION

European Patent No. 0 414 208 B1 describes a steel crawler-type bar where production problems that are otherwise usual in the case of bars of steel are avoided. In the case of the embodiment, for the benefit of a high level of wear resistance and of a simple design, a higher weight is accepted compared to aluminum crawler-type bars. To this end, in cross section the steel bar comprises a U-bracket with two U limbs and in between one connecting bar, the first U limb of which having as an extension a connecting limb which is guided inward by means of a bend as well as after a further bend a blade which connects thereto and is approximately parallel to the U limbs. The embodiment is characterized in that the second U limb is bent inward and welded with the first connecting limb such that in cross section a cavity that is similar to a housing is formed, beyond which the first U limb protrudes.

### SUMMARY OF THE INVENTION

The object underlying the invention is to realize a crawler-type bar which protects in particular belts on which the crawler-type bars of a crawler chain are arranged.

The present invention proceeds from a crawler-type bar for a piste vehicle or a vehicle for traveling over snow-covered terrain, the crawler-type bar consisting of an elongated bar basic body and an edge which is realized over at least one third of the length of the basic body for intervention into the subsurface. The core of the invention is that the edge has several edge portions, that is as it were apportioned over the length of the basic body, the edge portions, when viewed transversely with respect to the direction of the bar, extending at a spacing and at least in part not overlapping with another bar portion. This means that over predefined portions in the longitudinal direction of the bar, no more than one edge is present.

As a result of the edge portions being arranged at a spacing transversely with respect to the direction of the bar, a crawler-type bar is obtained which stands on a support surface, i.e. does not tip over, as the bar is able to be supported on the subsurface, for example, on two edge portions which are offset completely with respect to the bar. The advantage of this is that belts, on which the bar is mounted on a complete crawler chain, are not loaded by any overturning moment when standing, but merely transmits, vertical forces onto the surface of the belts because the crawler-type bar does not tip up.

In a particularly preferred development of the invention, when viewed in the direction of the bar, the edge portions are spaced apart in parallel transversely with respect to the direction of the bar. This means that one edge portion is followed by another edge portion in the longitudinal direction, but offset in parallel. Consequently, when looking in the direction of the bar, that is in the side projection of the bar portions, a U-shaped form is produced with in particular two limbs of identical length, defined by the offset edge portions.

In principle, the edge portions could also comprise different heights, preferably however not such a great difference in height that the crawler-type bar would tilt by a large amount in an unwanted manner with reference to crawler chain belts when at a standstill.

In an additionally advantageous development of the invention, the edge portions are arranged offset transversely with respect to the direction of the bar with and/or without overlap in the direction of the bar. When viewed in the longitudinal direction, the offset bar portions can also have gaps, that is they do not connect directly to one another. The gap can be filled, where applicable, with a further crawler-type bar component, such as, for example, an ice-gripping element which is set at an angle and protrudes beyond the edges, for example, an ice scraper which bears in each case against the end faces of the edge portions.

In order to obtain a simple design, it is additionally proposed that the bar basic body is realized as a box profile, on which the edge portions are arranged. The edge portions are preferably welded to the bar basic body, for example in the form of the box profile. In order to obtain a sturdy connection, edge portions in the form of an L-shaped profile are welded onto the basic bar body.

However, it is also conceivable for the edge portions to be screw-connected and/or bonded and/or riveted. The advantage of screw connection is that, where applicable, it is possible to replace worn edge portions.

In an embodiment of the present invention that is preferred over and above this, the edge portions comprise a substantially identical wall thickness in their height from the bar basic body. This is preferred, in particular, when a profile that is L-shaped in cross section is used as an edge, with two L-shaped limbs of identical thickness. Consequently, it is not necessary to have to realize other profile cross sections that are expensive.

The edge height of the edge portions is preferably at least 20, 30, 40, 50 millimeters. Depending on the subsurface, it is possible to adapt the edge height to the requirements generated thereby.

A plurality of crawler-type bars are arranged offset in an alternating manner in the longitudinal direction of the crawler-type bars on a complete crawler chain produced from crawler belts.

The respective crawler-type bars are preferably produced completely from steel, however other materials such as aluminum are also conceivable or material combinations such as aluminum/steel.

### BRIEF DESCRIPTION OF THE DRAWINGS

Two exemplary embodiments of the invention are shown in the Figures and are explained in more detail below together with further advantages and details.

FIG. 1 shows a three-dimensional view of a crawler-type bar according to the present invention; and

FIG. 2 shows an arrangement of several crawler-type bars according to FIG. 1 in a manner in which they are arranged on bands (not shown) of crawler chains.

### DETAILED DESCRIPTION OF THE INVENTION

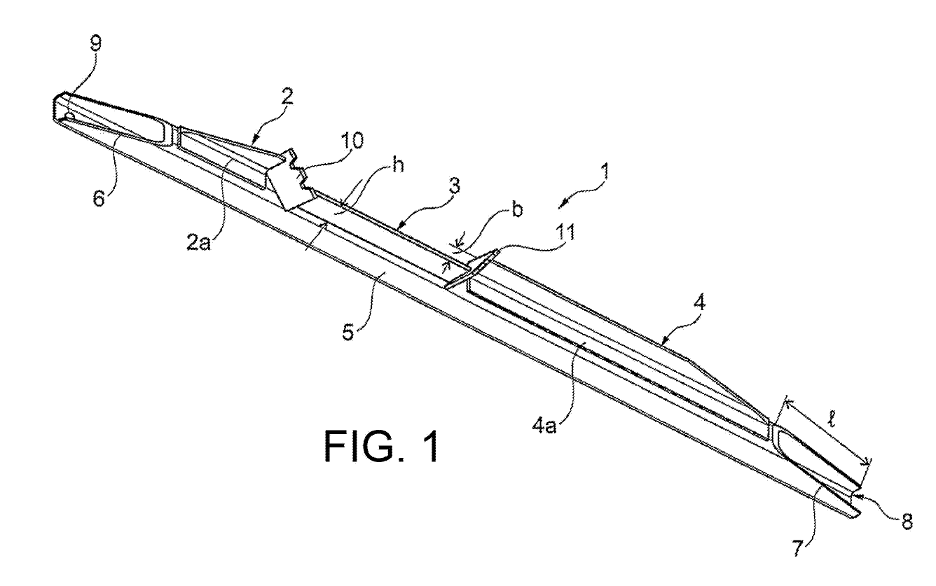

FIG. 1 shows a crawler-type bar 1 with edge portions 2, 3, 4. The edge portions 2, 3, 4 are arranged, in particular welded, on a bar basic body 5.

The bar basic body 5 has, for example, a box profile in cross section and is cut off obliquely at each of the ends 6, 7. Consequently, the box profile is open over a predefined length l such that access to a wall 8 of the box profile is possible from inside to outside, the crawler-type bar being subsequently screw-connected to a crawler belt of a crawler chain at the wall by means of bores 9 (only the bore 9 which is arranged on the outermost end 6 can be seen in FIG. 1).

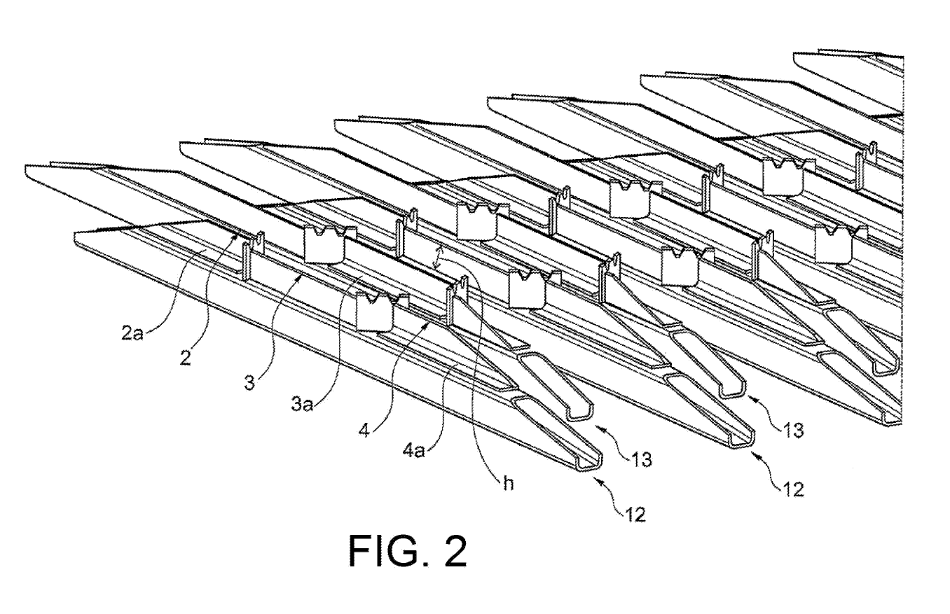

The edge portions 2, 3, 4 are in each case L-shaped in cross section, the edge portion 3, however, being mounted offset to the edge portions 2, 3 in such a manner that the respective limb 2a, 3a, 4a of the edge portions 2 and 4 (see FIG. 2 also in this connection) resting on the bar basic body 5 is arranged opposite the limb 3a of the edge portion 3.

As a result, the edge portions 2, 3, 4 are offset in parallel in the longitudinal direction of the crawler-type bar 1.

The amount of offset can be different and in FIG. 1, for example, is the size b and preferably a smaller value than the width of the bar basic body. The bar portions 2, 3, 4 preferably have an identical height h in each case except for an inclined attachment region on the outermost ends of the bar portions 2 and 4. Different heights are also conceivable. In order to achieve a stance of the crawler-type bar at right angles to the wall 8 on a surface, the bar portions 2, 3, 4 however preferably comprise identical heights.

In the exemplary embodiment, the bar portions 2, 3, 4 are connected to ice-gripping elements 10, 11 which in each case fill out gaps that are present in the longitudinal direction of the crawler-type bar between the edge portions 2 and 3 or 3 and 4. The ice-gripping elements preferably protrude beyond an upper edge of the edge portions 2, 3, 4 as can be seen in FIG. 1.

In FIG. 2, a plurality of crawler-type bars 12 and 13 are arranged in a manner as they would normally be mounted on belts (not shown) of a complete crawler chain. The crawler-type bars 13 correspond to the crawler-type bar according to FIG. 1. The crawler-type bars 12 differ somewhat in the length dimensioning, as a result of which the lengths of the edge portions 2, 3, 4 are also somewhat different to the lengths of the crawler-type bar 13 or the crawler-type bar according to FIG. 1.

The principle design, however, is the same.

### LIST OF REFERENCES

1 Crawler-type bar
2 Edge portion
2a Limb
3 Edge portion
3a Limb
4 Edge portion
4a Limb
5 Bar basic body
6 End
7 End
8 Wall
9 Bore
10 Ice-gripping element
11 Ice-gripping element
12 Crawler-type bar
13 Crawler-type bar

1. A crawler-type bar for a piste vehicle, said crawler-type bar comprising an elongated bar basic body and an edge which is realized over at least one third of the length of the basic body, wherein the edge has several edge portions which, when viewed transversely with respect to the direction of the bar, extend at a spacing and at least in part not overlapping with another bar portion.

2. The crawler-type bar according to claim 1, wherein, when viewed in the direction of the edge, edge portions are spaced apart in parallel transversely with respect to the direction of the bar.

3. The crawler-type bar according to claim 1, wherein the edge portions are arranged offset transversely with respect to the direction of the bar with and/or without overlap in the direction of the bar.

4. The crawler-type bar according to claim 1, wherein the bar basic body is realized as a box profile on which the edge portions are arranged.

5. The crawler-type bar according to claim 1, wherein the edge portions are welded.

6. The crawler-type bar according to claim 1, wherein the edge portions are screw-connected and/or bonded and/or riveted.

7. The crawler-type bar according to claim 1, wherein the edge portions are connected to ice-gripping elements which protrude beyond the edge portions.

8. The crawler-type bar according to claim 1, wherein the edge portions comprise a substantially identical wall thickness in their height from the bar basic body.

9. The crawler-type bar according to claim 1, wherein the edge height is at least 20 millimeters.

10. The crawler chain with crawler-type bars according to claim 1.

11. The crawler-type bar according to claim 1, wherein the edge height is at least 30 millimeters.

12. The crawler-type bar according to claim 1, wherein the edge height is at least 40 millimeters.

13. The crawler-type bar according to claim 1, wherein the edge height is at least 50 millimeters.
